(19) United States
(12) Patent Application Publication
(10) Pub. No.: US 2025/0282346 A1
(43) Pub. Date: Sep. 11, 2025

(54) VEHICLE COLLISION AVOIDANCE SUPPORT DEVICE, VEHICLE COLLISION AVOIDANCE SUPPORT METHOD, AND VEHICLE COLLISION AVOIDANCE SUPPORT PROGRAM

(71) Applicant: TOYOTA JIDOSHA KABUSHIKI KAISHA, Toyota-shi (JP)

(72) Inventor: Shimpei HIGASHINO, Atsugi-shi (JP)

(73) Assignee: TOYOTA JIDOSHA KABUSHIKI KAISHA, Toyota-shi (JP)

(21) Appl. No.: 19/006,554

(22) Filed: Dec. 31, 2024

(30) Foreign Application Priority Data
Mar. 5, 2024 (JP) 2024-033291

(51) Int. Cl. B60W 30/09; B60W 30/095

(52) U.S. Cl. CPC B60W 30/09; B60W 30/0953; B60W 30/0956

(57) ABSTRACT

The vehicle collision avoidance support device executes the collision avoidance control when the collision avoidance control is not executed and the collision condition is satisfied when the prohibition condition that the collision angle is equal to or larger than the predetermined threshold value is satisfied even when the collision condition that the host vehicle may collide with the target object is satisfied. The vehicle collision avoidance support device sets a predetermined threshold value so that the predetermined threshold value becomes smaller when the turning angle is large than when the turning angle is small.

### CROSS-REFERENCE TO RELATED APPLICATION

This application claims priority to Japanese Patent Application No. 2024-033291 filed on Mar. 5, 2024, incorporated herein by reference in its entirety.

### BACKGROUND

### 1. Technical Field

The present disclosure relates to a vehicle collision avoidance support device, a vehicle collision avoidance support method, and a vehicle collision avoidance support program.

### 2. Description of Related Art

There is known a vehicle collision avoidance support device that executes collision avoidance control for avoiding a collision between a host vehicle and a target. As such a vehicle collision avoidance support device, there is known a vehicle collision avoidance support device configured to: predict a turning path of the host vehicle and a moving path of a target; acquire, as a collision angle, an angle between the traveling direction of the host vehicle at a point at which the predicted turning path and moving path intersect each other and a line orthogonal to the predicted moving path; not execute the collision avoidance control when a prohibition condition that the acquired collision angle is equal to or more than a predetermined threshold is met, even if a collision condition that there is a possibility that the host vehicle collides with the target is met; and execute the collision avoidance control when the collision condition is met, when the prohibition condition is not met (see Japanese Unexamined Patent Application Publication No. 2023-47497 (JP 2023-47497 A), for example). Further, as such a vehicle collision avoidance support device, there is also known a vehicle collision avoidance support device configured to: acquire, as a turning angle, an angle by which the host vehicle turns about the turning center; and set a predetermined threshold so as to be smaller when the acquired turning angle is larger than when the turning angle is smaller (see JP 2023-47497 A, for example).

### SUMMARY

Even after the change direction of the angular velocity of the steering angle of the host vehicle is reversed (i.e., after the returning operation of the steering of the host vehicle is started) after the host vehicle starts turning, the acquired collision angle tends to take a larger value as the turning angle is smaller. However, the actual collision angle at the time when the host vehicle collides with the target tends to be larger when the amount of the returning operation is smaller than when the amount of the returning operation is larger. Thus, if the predetermined threshold is uniformly changed regardless of the amount of the returning operation, it may be determined that it is not necessary to execute the collision avoidance control in a situation where it is necessary to execute the collision avoidance control.

An object of the present disclosure is to provide a vehicle collision avoidance support device, a vehicle collision avoidance support method, and a vehicle collision avoidance support program capable of avoiding it being determined that it is not necessary to execute collision avoidance control in a situation where it is necessary to execute collision avoidance control.

An aspect of the present disclosure provides a vehicle collision avoidance support device including
a control device that executes collision avoidance control for avoiding a collision between a host vehicle and a target ahead of the host vehicle.

The control device is configured to
predict a turning path of the host vehicle and a moving path of the target when the host vehicle is turning,
acquire, as a collision angle, an angle between a traveling direction of the host vehicle at a point at which the turning path and the moving path intersect each other and a line orthogonal to the moving path,
not execute the collision avoidance control when a prohibition condition that the collision angle is equal to or more than a predetermined collision angle threshold is met, even if a collision condition that there is a possibility that the host vehicle collides with the target is met, and
execute the collision avoidance control when the collision condition is met, when the prohibition condition is not met.

Further, the control device is configured to: acquire, as a turning angle, an angle by which the host vehicle has turned about a turning center since the host vehicle starts turning when the host vehicle is turning;
set the predetermined collision angle threshold so as to be smaller when the acquired turning angle is larger than when the turning angle is smaller; and
after a change direction of an angular velocity of a steering angle of the host vehicle is reversed after the host vehicle starts turning, set the predetermined collision angle threshold so as to be smaller when the acquired turning angle is larger than when the turning angle is smaller, and so as to be larger when the angular velocity is lower than when the angular velocity is higher.

While the collision angle is often approximately zero when the host vehicle collides with a target, the collision angle acquired while the host vehicle is turning tends to take a larger value as the turning angle is smaller. Thus, if the predetermined collision angle threshold is set to a constant value, it may be determined that it is necessary to execute the collision avoidance control in a situation where it is not necessary to execute the collision avoidance control. Thus, it is possible to avoid it being determined that it is necessary to execute the collision avoidance control in a situation where it is not necessary to execute the collision avoidance control, by making the predetermined collision angle threshold smaller when the turning angle is larger than when the turning angle is smaller.

On the other hand, even after the change direction of the angular velocity of the steering angle of the host vehicle is reversed (i.e., after the returning operation of the steering of the host vehicle is started) after the host vehicle starts turning, the acquired collision angle tends to take a larger value as the turning angle is smaller. However, the actual collision angle at the time when the host vehicle collides with the target tends to be larger when the amount of the returning operation is smaller than when the amount of the returning operation is larger. Thus, if the predetermined collision angle threshold is uniformly changed regardless of the amount of the returning operation, it may be determined that it is not necessary to execute the collision avoidance control in a situation where it is necessary to execute the collision avoidance control.

With the vehicle collision avoidance support device according to the present disclosure, after the change direction of the angular velocity of the steering angle of the host vehicle is reversed after the host vehicle starts turning, the predetermined collision angle threshold is set so as to be smaller when the turning angle is larger than when the turning angle is smaller, and so as to be larger when the angular velocity of the steering angle is lower than when the angular velocity of the steering angle is higher. Thus, it is possible to avoid it being determined that it is not necessary to execute the collision avoidance control in a situation where it is necessary to execute the collision avoidance control.

In the vehicle collision avoidance support device according to the present disclosure, the control device may be configured to predict the turning path based on a yaw rate of the host vehicle at each time after the host vehicle starts turning.

With the vehicle collision avoidance support device according to the present disclosure, the turning path is predicted based on the yaw rate of the host vehicle at each time. Thus, the turning path can be conveniently predicted.

An aspect of the present disclosure also provides a vehicle collision avoidance support method in which collision avoidance control for avoiding a collision between a host vehicle and a target ahead of the host vehicle is executed, the vehicle collision avoidance support method including predicting a turning path of the host vehicle and a moving path of the target when the host vehicle is turning, acquiring, as a collision angle, an angle between a traveling direction of the host vehicle at a point at which the turning path and the moving path intersect each other and a line orthogonal to the moving path, not executing the collision avoidance control when a prohibition condition that the collision angle is equal to or more than a predetermined collision angle threshold is met, even if a collision condition that there is a possibility that the host vehicle collides with the target is met, and executing the collision avoidance control when the collision condition is met, when the prohibition condition is not met.

The vehicle collision avoidance support method further includes:
acquiring, as a turning angle, an angle by which the host vehicle has turned about a turning center since the host vehicle starts turning when the host vehicle is turning;
setting the predetermined collision angle threshold so as to be smaller when the acquired turning angle is larger than when the turning angle is smaller; and
after a change direction of an angular velocity of a steering angle of the host vehicle is reversed after the host vehicle starts turning, setting the predetermined collision angle threshold so as to be smaller when the acquired turning angle is larger than when the turning angle is smaller, and so as to be larger when the angular velocity is lower than when the angular velocity is higher.

With the vehicle collision avoidance support method according to the present disclosure, it is possible to avoid it being determined that it is not necessary to execute the collision avoidance control in a situation where it is necessary to execute the collision avoidance control.

An aspect of the present disclosure further provides a vehicle collision avoidance support program in which
collision avoidance control for avoiding a collision between a host vehicle and a target ahead of the host vehicle is executed, the vehicle collision avoidance support program including predicting a turning path of the host vehicle and a moving path of the target when the host vehicle is turning,
acquiring, as a collision angle, an angle between a traveling direction of the host vehicle at a point at which the turning path and the moving path intersect each other and a line orthogonal to the moving path,
not executing the collision avoidance control when a prohibition condition that the collision angle is equal to or more than a predetermined collision angle threshold is met, even if a collision condition that there is a possibility that the host vehicle collides with the target is met, and
executing the collision avoidance control when the collision condition is met, when the prohibition condition is not met.

The vehicle collision avoidance support program further includes: acquiring, as a turning angle, an angle by which the host vehicle has turned about a turning center since the host vehicle starts turning when the host vehicle is turning;
setting the predetermined collision angle threshold so as to be smaller when the acquired turning angle is larger than when the turning angle is smaller; and
after a change direction of an angular velocity of a steering angle of the host vehicle is reversed after the host vehicle starts turning, setting the predetermined collision angle threshold so as to be smaller when the acquired turning angle is larger than when the turning angle is smaller, and so as to be larger when the angular velocity is lower than when the angular velocity is higher.

With the vehicle collision avoidance support program according to the present disclosure, it is possible to avoid it being determined that it is not necessary to execute the collision avoidance control in a situation where it is necessary to execute the collision avoidance control.

The constituent elements of the present disclosure are not limited to those according to the embodiment of the present disclosure described later with reference to the drawings. Other objects, other features, and accompanying advantages of the present disclosure will be readily understood from the description of the embodiment of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a vehicle collision avoidance support device according to an embodiment of the present disclosure;

FIG. 2 is a flowchart illustrating a routine executed by the vehicle collision avoidance support device according to the embodiment of the present disclosure;

FIG. 3 is a diagram illustrating a scene in which the host vehicle turns left;

FIG. 4 is a diagram illustrating a predicted turning path and a predicted moving path when the host vehicle is in a left turn initial stage;

FIG. 5 is a diagram illustrating a predicted turning path and a predicted moving path when the host vehicle is in a left turning middle panel;

FIG. 6 is a diagram showing a relation between an impact angle, a turning angle, and a prohibited area; and

FIG. 7 is a diagram illustrating a collision angle.

### DETAILED DESCRIPTION OF EMBODIMENTS

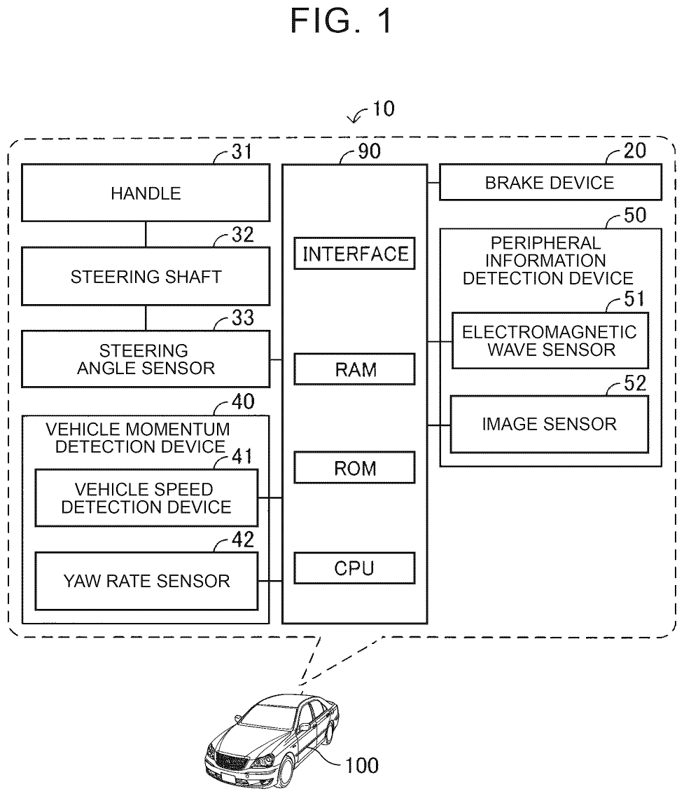

Hereinafter, a vehicle collision avoidance support device, a vehicle collision avoidance support method, and a vehicle collision avoidance support program according to an embodiment of the present disclosure will be described with reference to the drawings. FIG. 1 illustrates a vehicle collision avoidance support device 10 according to an embodiment of the present disclosure. The vehicle collision avoidance support device 10 is mounted on the host vehicle 100. Hereinafter, the vehicle collision avoidance support device 10 will be described by taking as an example a case where an operator of the host vehicle 100 is a person who rides on the host vehicle 100 and drives the host vehicle 100 (that is, a driver of the host vehicle 100).

However, the operator of the host vehicle 100 may be a person who drives the host vehicle 100 remotely without getting on the host vehicle 100 (that is, a remote operator of the host vehicle 100). When the operator of the host vehicle 100 is a remote operator, the vehicle collision avoidance support device 10 is mounted on the host vehicle 100 and a remote control facility installed outside the host vehicle 100 for remotely driving the host vehicle 100. The functions of the vehicle collision avoidance support device 10 described below are shared by the vehicle collision avoidance support device 10 mounted on the host vehicle 100 and the vehicle collision avoidance support device 10 mounted on the remote control facility, respectively.

As illustrated in FIG. 1, the vehicle collision avoidance support device 10 includes an ECU (electronic control device) 90 as a control device. The ECU 90 includes a microcomputer as a main part. The microcomputer includes a storage medium such as a CPU, ROM, RAM and a non-volatile memory, an interface, and the like. CPU implements various functions by executing instructions, programs, or routines stored in a storage medium. In particular, in the present example, the vehicle collision avoidance support device 10 stores, in a storage medium, a program for realizing various kinds of control executed by the vehicle collision avoidance support device 10.

In the present embodiment, the vehicle collision avoidance support device 10 includes only one ECU 90, but may include a plurality of ECU, and may be configured to share the functions of the vehicle collision avoidance support device 10 described below by the respective ECU.

Further, the vehicle collision avoidance support device 10 may be configured to be able to update a program stored in a storage medium by wireless communication (for example, Internet communication) with an external apparatus.

A braking device 20 is mounted on the host vehicle 100. The braking device 20 is a device that outputs a braking torque (braking force) applied to the host vehicle 100 for braking the host vehicle 100, and is, for example, a brake device. The braking device 20 is electrically connected to ECU 90. ECU 90 can control the braking torque outputted from the braking device 20 by controlling the operation of the braking device 20.

Further, the host vehicle 100 is equipped with a steering wheel 31, a steering shaft 32, a steering angle sensor 33, a vehicle momentum detection device 40, and a peripheral information detection device 50.

The steering angle sensor 33 is a sensor that detects the rotational angle of the steering shaft 32 with respect to the neutral position, and is electrically connected to ECU 90. The steering angle sensor 33 transmits the detected rotational angle of the steering shaft 32 to ECU 90. ECU 90 acquires the rotational angle of the steering shaft 32 as the steering angle θst on the basis of the information. In the present embodiment, when the steering wheel 31 is rotated clockwise and the steering shaft 32 is rotated clockwise, ECU 90 acquires a positive steering angle θst. Further, ECU 90 acquires a negative steering angle θst when the steering wheel 31 is rotated counterclockwise and the steering shaft 32 is rotated counterclockwise. When the steering wheel 31 is in the neutral position and therefore the steering shaft 32 is in the neutral position, the steering angle θst acquired by ECU 90 is zero.

The vehicle momentum detection device 40 is a device that detects the momentum of the host vehicle 100, and in the present example, includes a vehicle speed detection device 41 and a yaw rate sensor 42.

The vehicle speed detection device 41 is a device that detects the traveling speed of the host vehicle 100, and includes, for example, a wheel speed sensor. The vehicle speed detection device 41 is electrically connected to the ECU 90. The vehicle collision avoidance support device 10 acquires the traveling speed of the host vehicle 100 as the host vehicle speed Vego by the vehicle speed detection device 41.

The yaw rate sensor 42 is a sensor that detects the yaw rate of the host vehicle 100 and is electrically connected to ECU 90. The vehicle collision avoidance support device 10 acquires the yaw rate of the host vehicle 100 as the yaw rate YR by the yaw rate sensor 42.

The peripheral information detection device 50 is a device that detects information about the surroundings of the host vehicle 100, and in the present example, includes an electromagnetic wave sensor 51 such as a radar sensor and an image sensor 52 such as a camera sensor. The electromagnetic wave sensor 51 and the image sensor 52 are electrically connected to ECU 90. The vehicle collision avoidance support device 10 acquires data (target information IO) related to a target existing in the vicinity of the host vehicle 100 as the peripheral information IS by the electromagnetic wave sensor 51. Further, the vehicle collision avoidance support device 10 acquires image data (image information IC) in front of the host vehicle 100 as the peripheral information IS by the image sensor 52.

### Operation of Vehicle Collision Avoidance Support Device

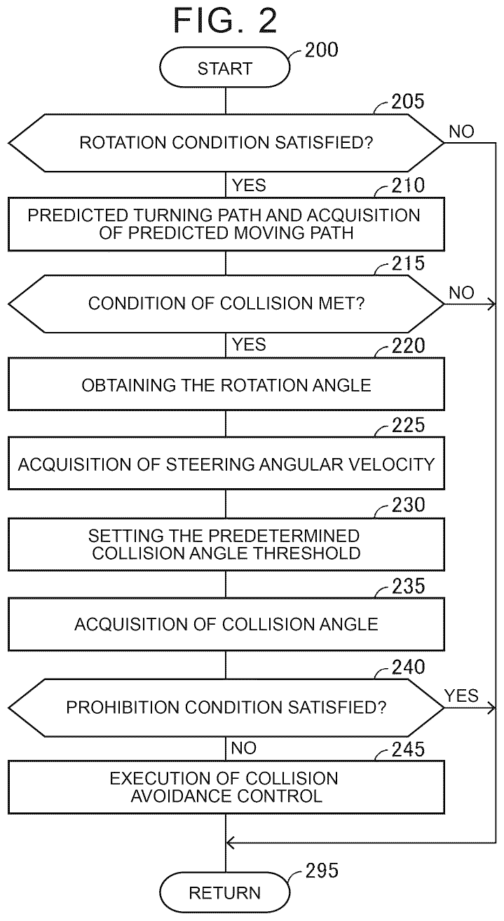

Next, the operation of the vehicle collision avoidance support device 10 will be described. The vehicle collision avoidance support device 10 is configured to execute collision avoidance control as automatic driving control when a predetermined condition is satisfied when the host vehicle 100 is turning by executing the routine illustrated in FIG. 2 at a predetermined calculation cycle.

The collision avoidance control is a control for avoiding a collision between the host vehicle 100 and a target in front of the host vehicle 100. In the present example, the collision avoidance control is a control in which the host vehicle 100 is automatically braked and stopped before colliding with a target object in order to avoid collision of the host vehicle 100 while turning on a target object such as a pedestrian crossing a road at the right turn or a road at the left turn (in particular, a crosswalk installed on the road) when the host vehicle 100 turns right or left at an intersection or the like.

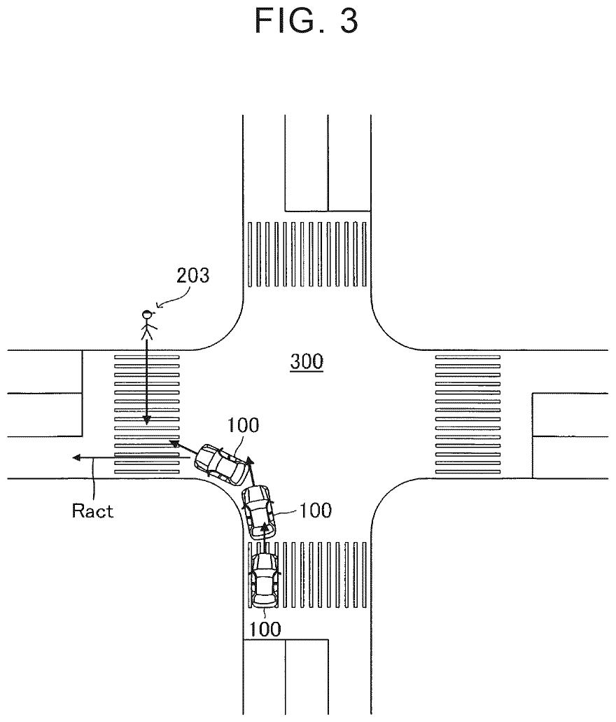

For example, as shown in FIG. 3, in a case where there is a pedestrian 203 crossing a crosswalk installed on a road that turns left when the host vehicle 100 turns left, the collision avoidance control is a control of automatically braking the host vehicle 100 to stop before colliding with the pedestrian 203 in order to avoid collision of the host vehicle 100 with the pedestrian 203.

At a predetermined timing, the vehicle collision avoidance support device 10 starts the processing from S200 of the routine shown in FIG. 2, advances the processing to S205, and determines whether or not the turning-condition C1 is satisfied.

The turning condition C1 is a condition that the host vehicle 100 is turning. The vehicle collision avoidance support device 10 determines that the host vehicle 100 is turning when the steering angle θst is larger than zero and when the steering angle θst is smaller than zero. In particular, the vehicle collision avoidance support device 10 determines that the host vehicle 100 is turning right when the steering angle θst is larger than zero, and determines that the host vehicle 100 is turning left when the steering angle θst is smaller than zero.

When S205 determines “Yes”, the vehicle collision avoidance support device 10 advances the process to S210 and acquires the predicted turning path Rego and the predicted moving path Rtgt. That is, the vehicle collision avoidance support device 10 predicts the turning path of the host vehicle 100 and the moving path of the target object 200 when the host vehicle 100 is turning.

The predicted turning path Rego is a path on which the host vehicle 100 is predicted to travel during turning. In the present embodiment, the vehicle collision avoidance support device 10 acquires the predicted turning path Rego based on the vehicle speed Vego and the yaw rate YR. The predicted turning path Rego can be acquired by a known method (for example, a method described in Japanese Unexamined Patent Application Publication No. 2023-47497 (JP 2023-47497 A)).

The predicted moving path Rtgt is a path predicted as a path along which the target object 200 moves. In this embodiment, the vehicle collision avoidance support device 10 acquires the predicted moving path Rtgt based on the moving velocity Vtgt of the target object 200 and the moving-direction Dtgt of the target object 200. The predicted moving path Rtgt can be acquired by a known method (for example, a method described in JP 2023-47497 A). Further, the vehicle collision avoidance support device 10 detects the target object 200 based on the peripheral information IS, and acquires the moving-velocity Vtgt of the target object 200 and the moving-direction Dtgt of the target object 200 based on the peripheral information IS.

Next, the vehicle collision avoidance support device 10 advances the process to S215, and determines whether or not the collision-condition C2 is satisfied.

The collision condition C2 is a condition that the host vehicle 100 and the target object 200 may collide with each other. In this embodiment, when the predicted turning path Rego and the predicted moving path Rtgt intersect each other and the intersection time difference T is equal to or less than the predetermined intersection time difference Tth and the predicted arrival time TTC is equal to or less than the predetermined predicted arrival time TTCth, the vehicle collision avoidance support device 10 determines that there is a possibility that the host vehicle 100 and the target object 200 collide with each other.

The intersection time difference T is a difference between a time at which the host vehicle 100 is expected to reach a point where the predicted turning route Rego and the predicted moving route Rtgt intersect and a time at which the target object 200 is expected to reach the intersection.

The predicted arrival time TTC is a time required for the host vehicle 100 (particularly, a point at the center of the vehicle width-direction at the leading edge of the host vehicle 100) to reach the predicted travel route Rtgt when the host vehicle 100 travels while maintaining the current time. The vehicle collision avoidance support device 10 calculates the predicted arrival time TTC by, for example, dividing the distance traveled by the host vehicle 100 until reaching the predicted travel route Rtgt by the host vehicle speed Vego at the current time. Further, the predetermined intersection time difference Tth is set to an intersection time difference T in which the host vehicle 100 and the target object 200 may touch each other.

Whether or not there is a possibility that the host vehicle 100 and the target object 200 collide with each other can be determined by a known manual method (for example, a method described in JP 2023-47497 A).

Incidentally, as shown in FIG. 3, when the host vehicle 100 turns left at the intersection 300, the steering angle of the host vehicle 100 gradually increases from the start of the left turn to the middle wheel thereof, and gradually decreases when the vehicle exceeds the middle wheel of the left turn, and becomes zero when the left turn is completed. Therefore, generally, the turning radius of the route (actual turning route Ract) on which the host vehicle 100 actually travels at the time of turning left becomes gradually smaller from the beginning of turning left to the middle panel, and becomes gradually larger when it exceeds the middle panel of turning left, and becomes infinite after the completion of turning left. That is, after the completion of the left turn, the host vehicle 100 travels straight. Therefore, the actual turning path Ract after the completion of the left turn of the host vehicle 100 is a straight path as shown in FIG. 3.

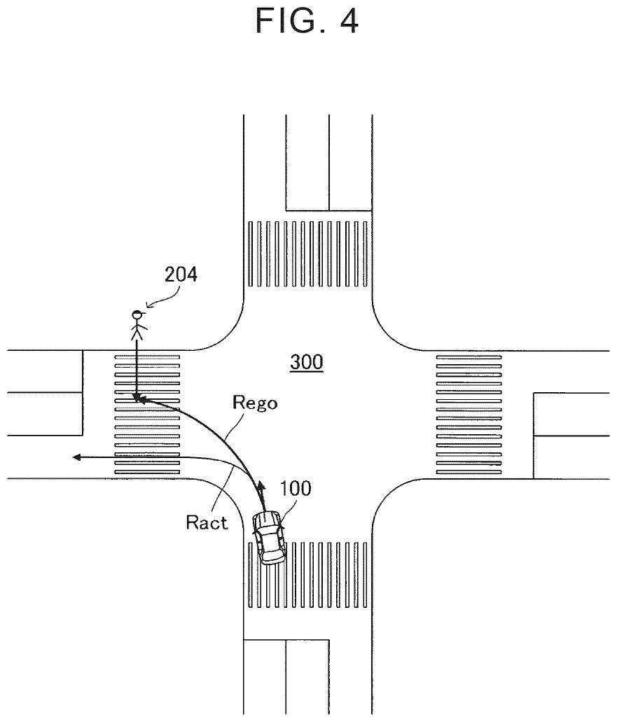

On the other hand, in the present embodiment, the vehicle collision avoidance support device 10 acquires the predicted turning path Rego by using the yaw rate YR. Therefore, for example, as illustrated in FIG. 4, the predicted turning path Rego acquired until the host vehicle 100 reaches the middle panel of the left turn becomes a path passing through the right side of the actual turning path Ract in the area of the road of the left turn destination, and tends to deviate from the actual turning path Ract. On the other hand, the predicted turning path Rego acquired when the host vehicle 100 is in the middle of the left turn becomes a path passing through the left side of the actual turning path Ract in the area of the road of the left turn destination, and tends to deviate from the actual turning path Ract.

Therefore, as shown in FIG. 4, if the predicted turning path Rego is a path passing through the right side of the actual turning path Ract in the area of the road of the left turn destination, even if the collision condition C2 is satisfied for the pedestrian 204 on the pedestrian on the road of the left turn destination, the host vehicle 100 does not collide with the pedestrian 204 as long as the appropriate left turn is actually performed. When the collision avoidance control is executed in such a situation, unnecessary execution of the collision avoidance control is performed.

Similarly, if the predicted turning path Rego is a path passing through the left side of the actual turning path Ract in the area of the road at the left turn destination, even if the collision condition C2 is established for the pedestrian on the pedestrian on the road at the left turn destination, the host vehicle 100 does not collide with the pedestrian as long as the appropriate left turn is actually performed. When the collision avoidance control is executed in such a situation, unnecessary execution of the collision avoidance control is performed.

Here, in a case where the host vehicle 100 collides with a pedestrian crossing the road of the left turn destination, the host vehicle 100 collides with such a pedestrian immediately before or after the completion of the left turn and the start of the straight travel. Therefore, the angle formed by the traveling direction of the host vehicle 100 and the moving direction of the pedestrian when the host vehicle 100 and the pedestrian collide with each other is approximately 90°. Therefore, in general, the angle formed between the traveling direction of the host vehicle 100 and the moving direction of the pedestrian is a value that is relatively largely deviated from 90° until the host vehicle 100 is placed in the left-turn middle panel. However, as the turning of the host vehicle 100 progresses, the angle formed by the traveling direction of the host vehicle 100 and the moving direction of the pedestrian gradually approaches 90°, and finally, when the host vehicle 100 and the pedestrian collide with each other, the angle becomes a value around 90°.

Therefore, the amount of deviation of the angle formed between the traveling direction of the host vehicle 100 and the moving direction of the pedestrian from 90° is acquired as the collision angle θcol until the turning ends after the host vehicle 100 starts turning. When the collision angle θcol is equal to or larger than the predetermined collision angle threshold value θcol_th, the execution of the collision avoidance control is prohibited, and the predetermined collision angle threshold value θcol_th is set to a smaller value as the angle of turning around the turning center of the turning is increased after the host vehicle 100 starts turning. Accordingly, it is possible to suppress unnecessary execution of the collision avoidance control.

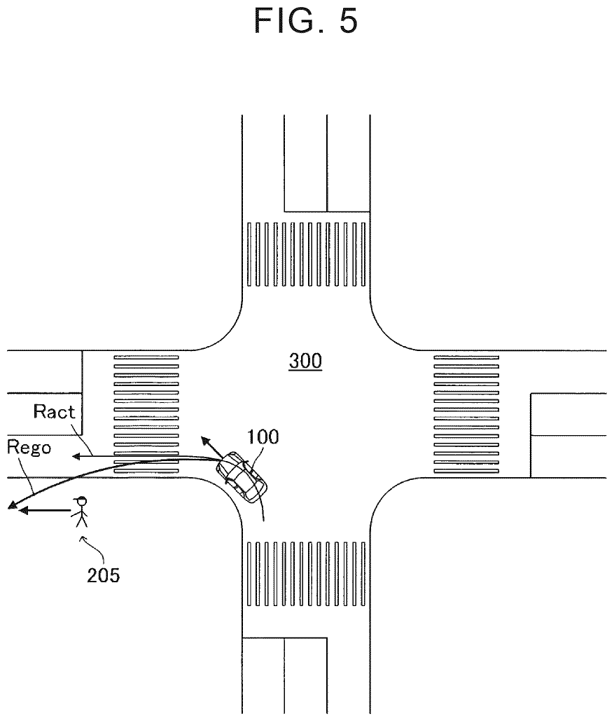

However, as shown in FIG. 5, when there is a pedestrian 205 who moves in the same direction as the moving direction of the host vehicle 100 after the left turn is completed, if the turning-back steering of the host vehicle 100 is appropriate, then the host vehicle 100 travels straight. On the other hand, when the turning-back steering of the host vehicle 100 is insufficient, the host vehicle 100 travels on a route close to the predicted turning route Rego. Therefore, when the same predetermined collision angle threshold value θcol_th is set for the same turning angle θego, the execution of the collision avoidance control is prohibited in a case where the turning-back steering of the host vehicle 100 is insufficient and there is a possibility that the host vehicle 100 collides with the pedestrian 205.

The switching-back steering is a steering performed by a driver. The switchback steering is a steering in which the steering wheel 31 is rotated in the left direction to turn the host vehicle 100 to the left and then rotated in the right direction, and a steering in which the steering wheel 31 is rotated in the right direction to turn the host vehicle 100 to the right and then rotated in the left direction. In other words, the switching-back steering is a steering that reverses the direction of change in the angular velocity of the steering angle of the host vehicle 100 after the turning of the host vehicle 100 is started.

As described above, in order to avoid prohibition of execution of the collision avoidance control when there is a possibility that the host vehicle 100 collides with the pedestrian 205, the vehicle collision avoidance support device 10 executes S220 to S240 processes when it is determined as “Yes” in S215.

That is, when S215 determines “Yes”, the vehicle collision avoidance support device 10 advances the process to S220 and acquires the turning angle θego. The turning angle θego is an angle at which the own-vehicle 100 turns from the time when the turning-condition C1 is satisfied to the present time. In other words, the turning angle θego is an angle at which the host vehicle 100 has turned around the turning center of the turning after the turning is started. The vehicle collision avoidance support device 10 acquires the turning angle θego based on the host vehicle speed Vego, the steering angle θst, and the like.

Next, the vehicle collision avoidance support device 10 advances the process to S225 and acquires the steering angular velocity ω. The steering angular velocity ω is a change amount of the steering angle θst per unit time.

Next, the vehicle collision avoidance support device 10 advances the process to S235, and sets the predetermined collision angle threshold θcol_th based on the turning angle θego acquired by S220 and the steering angular velocity ω acquired by S225. Specifically, the predetermined collision angle threshold θcol_th is set as follows.

That is, before the switchback steering is started, regardless of the steering angular velocity ω, the predetermined collision angle threshold θcol_th is set to a smaller value when the swing angle θego is large than when the swing angle θego is small.

On the other hand, when the steering angular velocity ω is the same after the switchback steering is started, the predetermined collision angle threshold value θcol_th is set to a smaller value when the turning angle θego is large than when the turning angle θego is small. When the turning angle θego is the same, the predetermined collision angle threshold θcol_th is set to a larger value when the steering angular velocity ω is small than when the steering angular velocity ω is large. More specifically, in the present example, before the switchback steering is started, the predetermined collision angle threshold value θcol_th is set to a smaller value as the turning angle θego increases, irrespective of the steering angular velocity ω.

On the other hand, when the steering angular velocity ω is the same after the switchback steering is started, the predetermined collision angle threshold value θcol_th is set to a smaller value as the turning angle θego is larger. When the turning angle θego is the same, the predetermined collision angle threshold θcol_th is set to a larger value as the steering angular velocity ω is smaller. In this example, the predetermined collision angle threshold value θcol_th is set to a smaller value as the turning angle θego increases even after the start of the switchback steering.

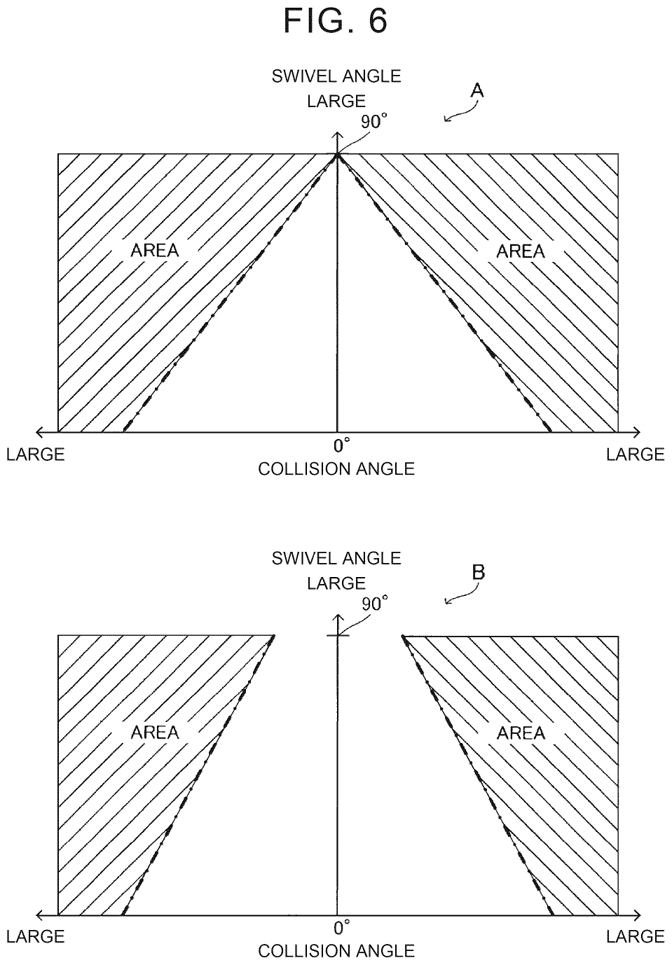

According to this, when the steering angular velocity ω is relatively large, the area AREA for prohibiting the execution of the collision avoidance control is set as indicated by reference numeral A in FIG. 6. When the steering angular velocity ω is relatively small, as indicated by reference numeral B in FIG. 6, an area AREA for prohibiting the execution of the collision avoidance control is set. In the graph shown in FIG. 6, the horizontal axis represents the collision angle θcol, and the vertical axis represents the turning angle θego.

That is, the vehicle collision avoidance support device 10 is configured to set the predetermined collision angle threshold value θcol_th so that the predetermined collision angle threshold value θcol_th becomes smaller as the obtained turning angle θego becomes larger. The vehicle collision avoidance support device 10 is configured to set the predetermined collision angle threshold value θcol_th such that, after the turning start of the host vehicle 100, after the change direction of the angular velocity (steering angular velocity ω) of the steering angle of the host vehicle 100 is reversed (after the switching-back operation is started), the predetermined collision angle threshold value θcol_th becomes smaller as the acquired turning angle θego is larger and the predetermined collision angle threshold value θcol_th becomes larger as the angular velocity (steering angular velocity ω) is smaller.

The vehicle collision avoidance support device 10 may be configured to set the predetermined collision angle threshold value col_th so that the predetermined collision angle threshold value θcol_th becomes smaller when the obtained turning angle θego is large than when the turning angle θego is small. In this case, the vehicle collision avoidance support device 10 may be configured to set the predetermined collision angle threshold value θcol_th such that, after the change direction of the angular velocity (steering angular velocity ω) of the steering angle of the host vehicle 100 is reversed after the start of turning of the host vehicle 100 (after the start of the switching-back operation), the predetermined collision angle threshold value θcol_th becomes smaller when the obtained turning angle θego is large than when the turning angle θego is small and the predetermined collision angle threshold value θcol_th becomes larger when the angular velocity (steering angular velocity ω) is small than when the angular velocity (steering angular velocity ω) is large.

Next, the vehicle collision avoidance support device 10 advances the process to S235 and acquires the collision-angle θcol.

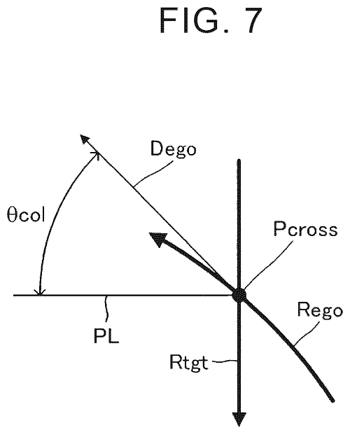

As described above, the collision angle θcol is an amount by which an angle formed between the traveling direction of the host vehicle 100 and the moving direction of the pedestrian deviates from 90°. More specifically, as illustrated in FIG. 7, the collision angle θcol is an angle formed by a traveling direction (predicted traveling direction Dego) of the host vehicle 100 at the intersection Pcross and a line (quadrature line PL) perpendicular to the predicted traveling route Rtgt. The intersection Pcross is a point at which the predicted turning path Rego intersects the predicted moving path Rtgt.

That is, in S235, the vehicle collision avoidance support device 10 acquires, as the collision angle θcol, an angle between the traveling direction of the host vehicle 100 and a line (quadrature line PL) perpendicular to the predicted traveling path Rtgt at a point (intersection Pcross) where the predicted turning path Rego and the predicted traveling path Rtgt intersect with each other (predicted traveling direction Dego).

Next, the vehicle collision avoidance support device 10 advances the process to S240, and determines whether or not the prohibition condition C3 is satisfied based on the collision angle θcol obtained by S235 and the predetermined collision angle threshold θcol_th set by S230. The prohibition condition C3 is a condition that the collision angle θcol is equal to or larger than the predetermined collision angle threshold θcol_th. That is, the vehicle collision avoidance support device 10 determines whether or not the prohibition condition C3 that the collision angle θcol is equal to or greater than the predetermined collision angle threshold is satisfied in S240.

When S240 determines “Yes”, the vehicle collision avoidance support device 10 directly advances the process to S295, and ends the process of this routine temporarily without executing the collision avoidance control. That is, when the prohibition condition C3 is satisfied, the vehicle collision avoidance support device 10 is configured not to execute the collision avoidance control even if the collision condition C2 is satisfied.

On the other hand, when S240 determines “No”, the vehicle collision avoidance support device 10 advances the process to S245 and executes collision avoidance control. Next, the vehicle collision avoidance support device 10 advances the processing to S295, and ends the processing of the routine once. That is, when the prohibition condition C3 is not satisfied, the vehicle collision avoidance support device 10 executes the collision avoidance control when the collision condition C2 is satisfied.

When S205 determines “No” or when S215 determines “No”, the vehicle collision avoidance support device 10 directly advances the process to S295 and ends the process. In this case, the collision avoidance control is not executed.

The above is the operation of the vehicle collision avoidance support device 10.

According to this, after the change direction of the steering angular velocity ω is reversed after the start of turning of the host vehicle 100, the predetermined collision angle threshold value θcol_th is set such that the predetermined collision angle threshold value θcol_th becomes smaller as the turning angle θego becomes larger and the predetermined collision angle threshold value θcol_th becomes larger as the steering angular velocity ω becomes smaller. Therefore, it is possible to avoid that it is determined that the execution of the collision avoidance control is not necessary in a situation where the execution of the collision avoidance control is necessary.

The present disclosure is not limited to the above embodiment, and various modifications can be adopted within the scope of the present disclosure.

For example, the vehicle collision avoidance support device 10 may be configured to set the predetermined collision angle threshold θcol_th as follows.

That is, the vehicle collision avoidance support device 10 described above is configured to set the predetermined collision angle threshold value θcol_th so that the smaller the steering angular velocity ω is, the larger the predetermined collision angle threshold value θcol_th is.

However, the vehicle collision avoidance support device 10 may be configured to store in advance a map according to the characteristic indicated by reference numeral A in FIG. 6 and a map according to the characteristic indicated by reference numeral B in FIG. 6 as a map for acquiring the predetermined collision angle threshold value θcol_th using the collision angle θcol and the turning angle θego as arguments. In this case, when the steering angular velocity ω is equal to or less than the predetermined steering angular velocity ωth after the switchback steering is started, the vehicle collision avoidance support device 10 determines whether or not the prohibition condition C3 is satisfied by using the predetermined collision angle threshold θcol_th obtained by using the collision angle θcol and the turning angle θego as arguments from the map according to the characteristic indicated by reference numeral B in FIG. 6. Then, when the steering angular velocity ω is larger than the predetermined steering angular velocity ωth, the vehicle collision avoidance support device 10 is configured to determine whether or not the prohibition condition C3 is satisfied by using the predetermined collision angle threshold θcol_th obtained by using the collision angle θcol and the turning angle θego as arguments from the map according to the property indicated by reference numeral A in FIG. 6.

What is claimed is:

1. A vehicle collision avoidance support device comprising a control device that executes collision avoidance control for avoiding a collision between a host vehicle and a target ahead of the host vehicle, the control device being configured to
predict a turning path of the host vehicle and a moving path of the target when the host vehicle is turning,
acquire, as a collision angle, an angle between a traveling direction of the host vehicle at a point at which the turning path and the moving path intersect each other and a line orthogonal to the moving path,
not execute the collision avoidance control when a prohibition condition that the collision angle is equal to or more than a predetermined collision angle threshold is met, even if a collision condition that there is a possibility that the host vehicle collides with the target is met, and
execute the collision avoidance control when the collision condition is met, when the prohibition condition is not met, wherein the control device is configured to:
acquire, as a turning angle, an angle by which the host vehicle has turned about a turning center since the host vehicle starts turning when the host vehicle is turning;
set the predetermined collision angle threshold so as to be smaller when the acquired turning angle is larger than when the turning angle is smaller; and
after a change direction of an angular velocity of a steering angle of the host vehicle is reversed after the host vehicle starts turning, set the predetermined collision angle threshold so as to be smaller when the acquired turning angle is larger than when the turning angle is smaller, and so as to be larger when the angular velocity is lower than when the angular velocity is higher.

2. The vehicle collision avoidance support device according to claim 1, wherein the control device is configured to predict the turning path based on a yaw rate of the host vehicle at each time after the host vehicle starts turning.

3. A vehicle collision avoidance support method in which collision avoidance control for avoiding a collision between a host vehicle and a target ahead of the host vehicle is executed, the vehicle collision avoidance support method including
predicting a turning path of the host vehicle and a moving path of the target when the host vehicle is turning,
acquiring, as a collision angle, an angle between a traveling direction of the host vehicle at a point at which the turning path and the moving path intersect each other and a line orthogonal to the moving path,
not executing the collision avoidance control when a prohibition condition that the collision angle is equal to or more than a predetermined collision angle threshold is met, even if a collision condition that there is a possibility that the host vehicle collides with the target is met, and
executing the collision avoidance control when the collision condition is met, when the prohibition condition is not met, the vehicle collision avoidance support method comprising:
acquiring, as a turning angle, an angle by which the host vehicle has turned about a turning center since the host vehicle starts turning when the host vehicle is turning;
setting the predetermined collision angle threshold so as to be smaller when the acquired turning angle is larger than when the turning angle is smaller; and
after a change direction of an angular velocity of a steering angle of the host vehicle is reversed after the host vehicle starts turning, setting the predetermined collision angle threshold so as to be smaller when the acquired turning angle is larger than when the turning angle is smaller, and so as to be larger when the angular velocity is lower than when the angular velocity is higher.

4. A vehicle collision avoidance support program in which collision avoidance control for avoiding a collision between a host vehicle and a target ahead of the host vehicle is executed, the vehicle collision avoidance support program including
predicting a turning path of the host vehicle and a moving path of the target when the host vehicle is turning,
acquiring, as a collision angle, an angle between a traveling direction of the host vehicle at a point at which the turning path and the moving path intersect each other and a line orthogonal to the moving path,
not executing the collision avoidance control when a prohibition condition that the collision angle is equal to or more than a predetermined collision angle threshold is met, even if a collision condition that there is a possibility that the host vehicle collides with the target is met, and
executing the collision avoidance control when the collision condition is met, when the prohibition condition is not met, the vehicle collision avoidance support program comprising:
acquiring, as a turning angle, an angle by which the host vehicle has turned about a turning center since the host vehicle starts turning when the host vehicle is turning;
setting the predetermined collision angle threshold so as to be smaller when the acquired turning angle is larger than when the turning angle is smaller; and
after a change direction of an angular velocity of a steering angle of the host vehicle is reversed after the host vehicle starts turning, setting the predetermined collision angle threshold so as to be smaller when the acquired turning angle is larger than when the turning angle is smaller, and so as to be larger when the angular velocity is lower than when the angular velocity is higher.
